(19) United States
(12) Patent Application Publication
(10) Pub. No.: US 2009/0160589 A1
(43) Pub. Date: Jun. 25, 2009

(54) DEVICE WITH AN ELECTROMAGNET, CLUTCH, AND METHOD FOR PRODUCING AN ELECTROMAGNET

(75) Inventor: Rainer KRAFFT, Heiligenberg (DE)

Correspondence Address: BURR & BROWN, PO BOX 7068, SYRACUSE, NY, 13261-7068, US

(73) Assignees: Linnig Trucktec GmbH, Markdorf (DE); (via EPAS)

(21) Appl. No.: 12/334,781

(22) Filed: Dec. 15, 2008

(30) Foreign Application Priority Data
Dec. 14, 2007 (DE) 10 2007 060 895.2

(51) Int. Cl. H01F 1/00

(52) U.S. Cl. 335/219

(57) ABSTRACT

The invention relates to an apparatus having an electromagnet, comprising a coil and magnetic-field guide means, which at least partially surround the coil. According to the invention, the coil is provided with a sprayed or cast casing, wherein the magnetic-field guide means are formed from a material which comprises ferromagnetic metal particles and plastic material. The invention also relates to a clutch having an apparatus such as this, and to a method for production of an electromagnet.

### BACKGROUND OF THE INVENTION

Apparatuses having an electromagnet which comprises a coil and a magnetic-field guide at least partially surrounding the coil are used for various technical applications. By way of example, clutch arrangements which comprise an electromagnet are used in motor vehicle technology, which must always satisfy and be optimized for relatively stringent requirements relating to technical operation as well as implementation and production. Economic operating aspects must be taken into account at the same time.

### SUMMARY OF THE INVENTION

An object of the present invention is to improve technical and financial aspects relating to apparatuses having an electromagnet, in particular clutches having an electromagnet, and methods for production of electromagnets.

Firstly, the invention is based on an apparatus having an electromagnet, comprising a coil and a magnetic-field guide at least partially surrounding the coil. By way of example, apparatuses such as these can be components in any desired arrangements with an electromagnet. One major aspect of the invention is that the magnetic-field guide is formed from a material which comprises ferromagnetic metal particles and plastic material. The material combination according to the invention for the production of the magnetic-field guide makes it possible to optimize and to advantageously further develop both technical characteristics of an electromagnet and the production of the apparatus having an electromagnet. The material choice according to the invention for the magnetic-field guide opens up various and completely new options for the production of electromagnets. In particular, modern production processes can be used, and correspondingly high-quality products can be produced.

Components manufactured essentially, for example, from steel blanks and created from sawn material, forged material or a casting material have always been used for known electromagnets. The steel blanks are processed further by machining. This has the particular disadvantage that complex production steps and corresponding processing machines are required, that material wastage is unavoidable, and that this involves additional effort for collecting and disposing of the waste material.

Furthermore, this process makes further process steps necessary. A coil, for example a copper coil, is then introduced in the component which has been produced by machining and essentially forms the magnetic-field guide and a coil housing, and this coil is surrounded by insulation material, and in particular is encapsulated in the metal housing. In order to allow the insulation material, for example a plastic insulator, to penetrate into the areas to be filled, it must retain the capability to flow, thus necessitating a minimum separation between sections of the coil and the component or the coil housing of at least one millimeter, if not a number of millimeters.

The overall production of the electromagnet is comparatively complicated and expensive. Furthermore, when a predetermined space is available for installation of the coil, only a part thereof or a reduced space is available for the formation of the magnetic field which is produced by the coil when current flows through it. This is because the space that is filled with insulation material reduces the magnetic efficiency of the electromagnet.

Furthermore, comparable disadvantages cannot be avoided either when using alternative production processes to that mentioned above. In this case, the metallic component is, or the magnetic-field guide is, produced by means of a process of shaping a sheet-metal part. For this purpose as well, appropriate distances are absolutely essential between the coil and adjacent sections of the sheet-metal shaped part, for introduction of the insulator or of an insulation material. In addition, when using sheet-metal parts, individual sheet-metal parts must generally be connected to one another by means of appropriate connection methods.

The proposed use of ferromagnetic metal particles mixed with a plastic material in order to form the magnetic-field guide means that the magnetic-field guide can be formed, in particular, using a casting or injection-molding method. By way of example, this makes it advantageously possible to provide widely differing shapes without any problems.

In particular, the previously normal waste material can be avoided. Furthermore, in comparison to the prior art, a comparatively higher effective magnetic force can be produced in a comparable predetermined installation area, as a result of which it is possible to entirely or virtually entirely avoid a gap between the coil and the magnetic-field guide, as a result of which this avoids corresponding attenuation of the magnetic field and of the magnetic force which can be applied by the electromagnet. If required, a relatively thin intermediate layer can be provided between the coil and the material of the magnetic-field guide, for electrical insulation of the coil, for example a thin casing composed, for example, of a film or a coating on the coil.

In particular, the magnetic-field guide can be arranged by injection molding around the coil, such that the guide extends all the way to the coil, or is directly adjacent to it. In particular, it is advantageous if the characteristics, which are formed by the ferromagnetic metal particles and the plastic material, for the magnetic-field guide are formed in the entire available area, or virtually in the entire available area, adjacent to the coil, as far as an external dimension of the electromagnet. In particular, the characteristics achieved by the proposed material mixture for the magnetic-field guide are thus continuous or without interruption over a maximum available section, since this area is, in particular, completely filled with the material mixture.

The magnetic-field guide comprises, for example, metal particles distributed in a plastic material. The magnetic-field guide can thus be regarded, from the physical/chemical points of view, as a heterogeneous mixture of metal particles and a plastic material, which are in each case in delimited phases. The addition of relatively small proportions of further accompanying components is not precluded.

The coil is preferably embedded in the magnetic-field guide which, in particular, forms major sections externally around the coil. In particular, the coil is positioned between the magnetic-field guide or is surrounded by the magnetic-field guide, like part of a shell. The coil itself can, for example, be closed in the form of a ring to form a shaft, for example with the coil having an approximately quadrilateral or rectangular external shape, with four outer faces, in the section which is defined by a longitudinal section through the axis. When used in an electromagnetic clutch, one of the four outer faces of the coil generally remains free of the magnetic-field guide. That outer face of the coil ring which remains free is, in particular, aligned with its flat face axially with respect to the axis and may be covered by material that is not magnetically permeable, or may remain free of material. In other words, in the situation under consideration, the magnetic-field guide is, in particular, present continuously on two opposite outer faces of the coil and on at least one further outer face which is located between the opposite outer faces.

The coil may be surrounded by the magnetic-field guide such that, when current flows through the coil, a magnetic field is effectively formed throughout the entire body of the magnetic-field guide. In particular, the magnetic-field guide is formed integrally or by a cohesive material area.

The thickness of the magnetic-field guide, that is to say the material thickness at right angles to the outer face of the coil is, in particular, continuously the same, or in a comparable order of magnitude. The thickness of the magnetic-field guide in particular corresponds to approximately half the width of the coil in the direction considered at right angles to the coil outer face, and possibly also two or more times the value. On the outside, the coil itself may, if required, be surrounded by comparatively very thin insulation, for example an insulated layer.

In section, the magnetic-field guide may surround the coil for example in a U-shape or like a channel, with the U-shape comprising two opposite limbs and an intermediate limb connecting them. One outer face of the coil which remains free thereof through the open side of the U-shaped magnetic-field guide means can remain, set back with respect to the end areas of the two limbs of the U-shaped magnetic-field guide.

The coil under consideration with the magnetic-field guide may, in particular, be part of an electromagnet in an electromagnetic clutch with friction surfaces which can be brought into contact with one another during the engagement process, for example in a friction-engaging clutch.

In particular, the composition of the material comprising ferromagnetic metal particles and the plastic material can be appropriately optimized for the respective application. For example, the metal of which the metal particles are composed can be varied with regard to magnetic permeability, surface hardness, stiffness, strength and the like, and the plastic material can be varied, for example, with regard to the temperature resistance, strength and flowing capability.

A further major aspect is that the magnetic-field guide is composed of a material which is produced on the basis of metal particles, has ferromagnetic characteristics and can flow or can be sprayed during production. In particular, the material can thus be shaped and combined with other components using proven methods such as casting, spraying or injection-molding methods. Any desired shape of the magnetic-field guide can therefore be formed in a particularly simple manner, even in geometrically or spatially difficult conditions. In particular, the material can be made such that it can flow and can be sprayed by providing, in addition to the metal component, comparatively small amounts of at least one further material or of an additional component. For example, the coil can be provided with a sprayed or cast casing which forms the magnetic-field guide and can be produced and processed as a plastic part, which is advantageous, and allows injection molding, for example, at temperatures of about 200 degrees Celsius, in particular at less than 200 degrees Celsius, but which, in the finished state, after the molten and sprayed-in material has been cured, behaves like a metal part with ferromagnetic characteristics, because of the metal particles, and has material characteristics which are advantageous for the relevant application, in particular being thermally highly stable and mechanically highly robust.

It is also particularly advantageous that further areas of the coil and/or of the magnetic-field guide can be extrusion coated in particular in a further working process or injection-molding process, for example in order to form a covered layer, which may also be non-metallic or ferromagnetic, or to form fitting parts on the previously formed cast or injection-molding component, for example stiffening parts, fitting elements, bearing units or parts which make it possible to fit cable holders.

In particular, the injection-molding method can be carried out with the molten material at temperatures of about 200° Celsius, in particular of less than 200 degrees Celsius, for example in particular 160 degrees Celsius.

It is also possible that the magnetic-field guide be formed from a material which has ferromagnetic metal particles making up a proportion of more than 80 percent by mass, and in particular about 95 percent by mass. In principle, proportions of even less than 80 percent by mass of the ferromagnetic metal particles are also possible. However, it has been found that, particularly if the proportion of the ferromagnetic metal particles is more than 90 percent by mass, a result which is optimum with respect to the technical requirements for the electromagnet can be achieved with a further material, in particular a plastic material.

It is also advantageous for the magnetic-field guide to be formed from a material which has a plastic material making up a proportion of up to 20 percent by mass, in particular about 5 to 7 percent by mass. Optimized production and ideal material characteristics of the magnetic-field guide can be achieved with this considerably smaller proportion of the plastic material in comparison to the at least one other material, in particular to the proportion of the metal particles.

In one advantageous embodiment of the apparatus according to the invention, the magnetic-field guide is formed completely as an injection-molded component. This makes it possible to simplify the production of the apparatus with an electromagnet, and the production of the electromagnet itself, and to make these production processes more effective.

Furthermore, it is advantageous for the magnetic-field guide to comprise a prefabricated housing part, in particular composed of a shaped steel body, for example a shaped metal sheet, on which the coil can be positioned. As an alternative to completely injection-molded magnetic-field guide, this makes it possible to use a housing part with comparatively thin walls, which may be desirable or advantageous in certain cases. For example, the coil can be used on the prefabricated housing part and, for example, can be fixed by casting with the material based on ferromagnetic metal particles.

In comparison to previous electromagnets, it is now possible, for example, to use shaped parts composed of steel or sheet steel which are shaped with relatively thin walls or are composed of sheet metal with a thin sheet thickness, thus allowing small shaping radii. In particular, this makes it possible to make better use of the physical space. In addition, comparatively low-cost shaping tools can be used to produce the thin-walled steel body.

The coil can then be positioned at the desired installation point in an area between sections of the thin-walled steel body. The intermediate spaces which remain in this case between the coil and the steel body can be filled with the material based on ferromagnetic metal particles, generally with a proportion of plastic material, or the coil can be at least partially extrusion coated, in particular by means of an injection-molding method.

A further major aspect of the invention relates to a clutch, in particular for a motor vehicle, for example a single-stage or multi-stage clutch for driving additional devices, such as a fan impeller. According to the invention, the clutch has one of the abovementioned apparatuses. This makes it possible to provide clutches, in particular electromagnetically operable clutches, in motor vehicles, which clutches have the advantages mentioned above. These clutches in particular have one or more annular injection-molded magnetic-field guides, encapsulated in which a coil, for example a copper coil, is accommodated.

Furthermore, the invention relates to a method for production of an electromagnet having a coil and having a magnetic-field guide at least partially surrounding the coil. The production method is distinguished in that the magnetic-field guide is formed by an injection-molding process. This allows the magnetic-field guide to be produced in a technically advantageous manner. In particular, different material characteristics can be chosen by suitable selection and composition of the material used for injection molding. The original material for the injection molding comprises, in particular, two components, a metallic component and a non-metallic component. In particular, the material is formed from a mixture as explained above, in particular based on ferromagnetic metal particles, with the addition of a plastic, in particular of a thermoplastic.

Comparatively complex shapes of the magnetic-field guide can advantageously be achieved by means of an injection-molding process. Shaping such as this for a magnetic-field guide which is produced by shaping or by a machining process from metal blanks would be considerably more complex to produce, or could be produced only uneconomically. In particular, waste material can be completely or virtually completely avoided. Furthermore, different material mixtures, leading to the formation of quasi-metal parts, can be processed effectively and variably with the injection molding using the procedure of the present invention, thus allowing rapid and flexible matching to different applications.

The magnetic-field guide is advantageously formed by extrusion coating of at least parts of the coil. By way of example, the coil is introduced into a mold, which determines the external geometry of the subsequent injection-molded magnetic-field guide, and the areas which remain free are then encapsulated with the molten material in the mold. Once the material has solidified and cured, the majority of the electromagnet arrangement is complete. The optimum space utilization is achieved by the material extending directly to the coil itself during the extrusion coating. In comparison to previous arrangements, the coil and/or the magnetic field guide can be made larger, with the same space conditions. The expression “magnetic-field guide” means, in particular, the elements in the electromagnet and around the coil, which have comparatively very high to extremely high magnetic permeability. If required, sections which remain free of the magnetic-field guide can also be formed without any problem in the electromagnet or on the coil, during the injection molding. For example, in the case of a coil with a rectangular cross section, one of the four outer faces may remain free of the proposed material, or can subsequently be provided with a magnetically isolating or poorly magnetically permeable material.

Furthermore, it is also possible to incorporate the coil in an area between sections of a housing part of the magnetic-field guide, and material which can be injection-molded is then introduced into free spaces between the coil and the sections of the housing part. The method can therefore also advantageously be used when the magnetic-field guide is intended not to be composed completely of the injection-molded material or the magnetic-field guide is intended to be formed adjacent to a neighboring part. For example, the magnetic-field guide may comprise an arrangement which, in addition to the part produced by injection molding, has a further element which is intended to be in the form of a housing part, for example part of a housing of the electromagnet. For example, a shaped body can be used, for example a thin-walled steel body composed of sheet metal, which can form a part of a metal housing for the electromagnet, but is also used as magnetic-field guide and has very high magnetic permeability which may be advantageous, for example for robustness reasons or for design reasons.

### BRIEF DESCRIPTION OF THE DRAWINGS

The prior art and the invention are explained in the figures, with respect to which further features and advantages will be explained in more detail on the basis of highly schematic exemplary embodiments according to the invention.

FIG. 1 shows a section through a schematically illustrated known apparatus having an electromagnet;

FIG. 2 shows a further schematic apparatus having an electromagnet according to the prior art;

FIG. 3 shows a section through a partially and schematically illustrated electromagnet according to the invention;

FIG. 4 shows a perspective view, obliquely from underneath, of an arrangement similar to that shown in FIG. 3; and

FIG. 5 shows a further section view through a schematically illustrated electromagnet according to the invention.

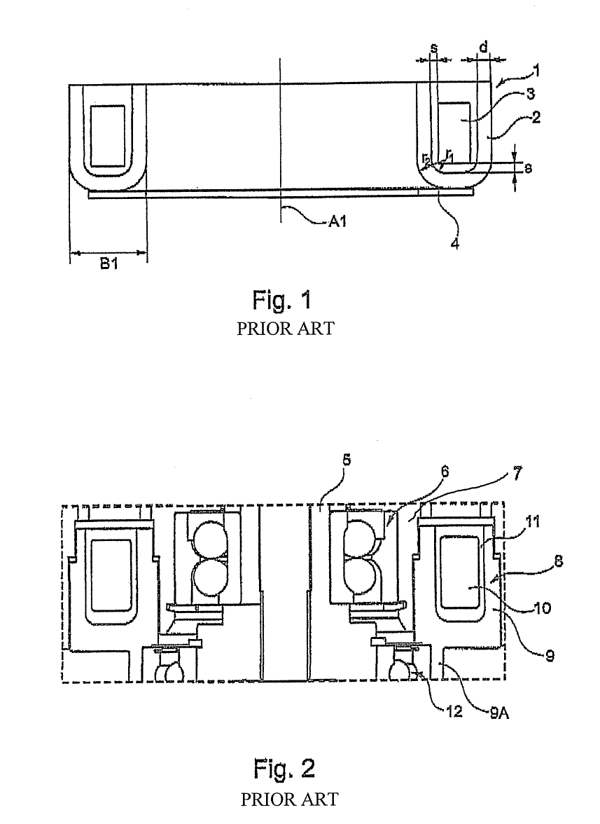

In order to improve the illustration, FIGS. 1 and 2 do not show an insulating encapsulation compound in which the respective coils of the electromagnet are embedded.

### DETAILED DESCRIPTION OF THE INVENTION

FIG. 1 shows, schematically, a section through a known annular electromagnet 1 in which, in order to simplify the illustration, individual parts and details are not illustrated. The electromagnet 1 comprises a U-shaped steel body 2 shaped from sheet-metal material. The steel body 2 is closed in an annular shape and is used to accommodate a likewise annular coil former 3, which is shown only schematically, with a rectangular cross section. In addition, FIG. 1 shows a flange ring 4 which, for example, can be used for fitting the electromagnet 1 to adjacent components. The flange ring 4 is fitted to the connecting part between the free limbs of the U-shaped steel body 2.

The sheet-metal thickness “d” of the steel body 2 composed of ferromagnetic material may, for example, be several millimeters, in this case about 5 mm, with the sheet-metal material forming a magnetic-field guide around the coil former 3. An installation area B1 is available in the radial direction, circumferentially around a central axis Al of the electromagnet 1. The coil former 3 is separated by approximately the same gap distance “s” of about 2-3 mm from the respective sections of the inner wall of the U-shaped steel body 2. This gap area cannot be chosen to be indefinitely small, and must be at least 1 mm in order to allow it to be encapsulated with an encapsulation compound composed of insulating material after the coil former 3 has been introduced between the limbs of the steel body 2, in order to electrically insulate the coil. A minimum gap size of, for example, 2 to 3 mm must be used in order to allow for flow or complete filling of the gap area with the insulation material in a reliable manner.

In addition, FIG. 1 shows the shaping radii r1 and r2 in the curved area of the steel body 2. Only a limited or confined installation area is available for the coil former 3 between the two limbs of the steel body 2 in the predetermined installation area B1 for the coil former 3 and the steel body 2 with the sheet-metal thickness “d” and the radii r1 and r2 which are dependent thereon, because of the gap distance “s” which must be maintained. Only a technically limited and comparatively reduced magnetic effective force can therefore be produced by the electromagnet when current flows through it, in comparison to a theoretically possible value without a gap distance “s”.

FIG. 2 shows a highly schematic detail of a known arrangement with an alternative electromagnet 8 in which case, in this case as well, and for the same reasons as explained with reference to FIG. 1, only a reduced magnetic effective force can be produced. The apparatus in which the electromagnet 8 is arranged circumferentially around a hollow shaft 5 comprises a ball-bearing arrangement 6 which is positioned radially inwards with respect to the electromagnet 8 and on whose outer ring a sleeve section 7 is supported. The electromagnet 8 comprises a U-shaped magnet body 9 which, for example, is produced from a ferromagnetic steel blank by a machining method. A coil 10 is accommodated in the U-shaped cutout of the magnet body 9.

Further components in FIG. 2 are illustrated highly schematically, and individual components are not illustrated, or are illustrated only partially.

An intermediate area 11 is provided between the coil 10 and inner wall sections of the magnet body 9, in which intermediate area 11 an encapsulation compound, which is not shown, is accommodated for electrical insulation of the coil 10 from the magnet body 9. A section 9A, which extends axially downwards on the magnet body 9 in FIG. 2, of the magnet body 9, is supported with respect to the shaft 5 by means of a further ball bearing 12.

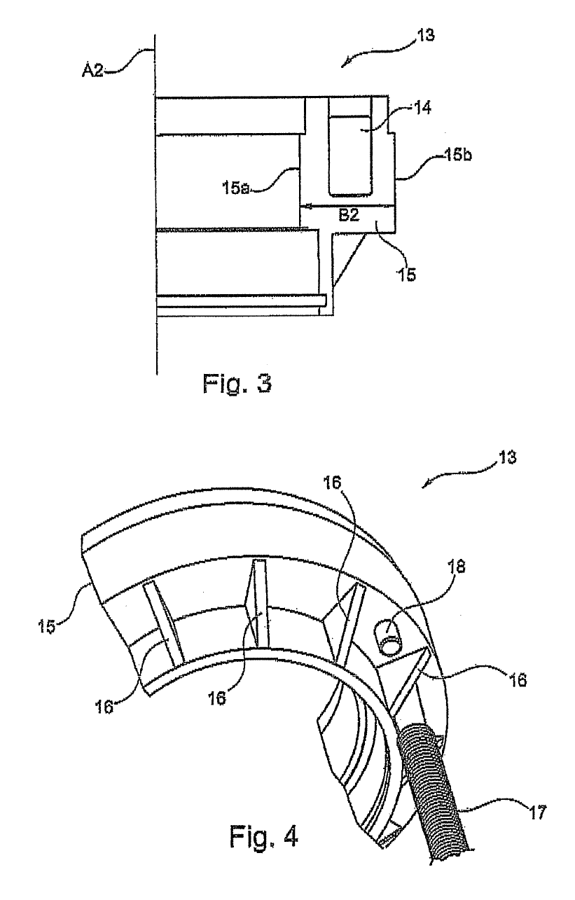

FIG. 3 shows a section through a partially illustrated electromagnet 13 of an apparatus according to the invention. The electromagnet 13 has a magnetic-field guide which is produced using an injection-molding process, in this case in the form of a magnetic-field guide element 15, which is arranged around a coil 14, which has a rectangular cross section and is once again illustrated in a highly schematic form. The coil 14 is extrusion coated with the guide element 15, or is firmly connected thereto, in that three of the four outer faces of the coil 14 make adhesive contact with the extrusion-coated material, after it has cured.

In particular, according to the invention, the coil 14 for the electromagnet 13 can be accommodated completely or interrupted and continuously surrounded by the magnetic-field guide element 15 between walls 15a and 15b lying radially inwards and radially outwards according to FIG. 3, in a predetermined installation area B2 which is available considered in the radial direction with respect to an axis A2. The magnetic-field guide element 15 is composed of a comparatively magnetically very permeable material which, in particular, is sprayed around the coil 14 in an injection-molding process. According to FIG. 3, an area without a magnetic-field guide element is shown above the coil 14, which is illustrated to have a rectangular cross section, in which case this area can likewise be filled with the material of the magnetic-field guide element 15, or alternatively can be filled with a magnetically insulating or poorly permeable material, or may remain free of material. An insulation layer for better electrical insulation can be introduced between a coil winding (not shown in detail), externally on the coil 14 and the adjacent sections of the magnetic-field guide element 15, and can sheath the coil, for example with a film or at least a shrink sleeve.

It is particularly advantageous that no gap or virtually no gap is required for an injection-molded insulation layer between the coil 14 and the magnetic-field guide element 15.

FIG. 4 shows, in perspective in the form of an oblique view from underneath, the sectioned part of a refinement of the electromagnet 13 which is similar to that shown in FIG. 3. In this case, stiffening outer ribs 16 can be seen, at a circumferentially uniform distance on the magnetic-field guide element 15, by means of an additional spraying process on the magnetic-field guide element 15, which has already been produced previously by injection molding. Furthermore, further elements are applied to the magnetic-field guide element 15, by means of a further injection-molding process, in this case by way of example, cable holders 17 and 18.

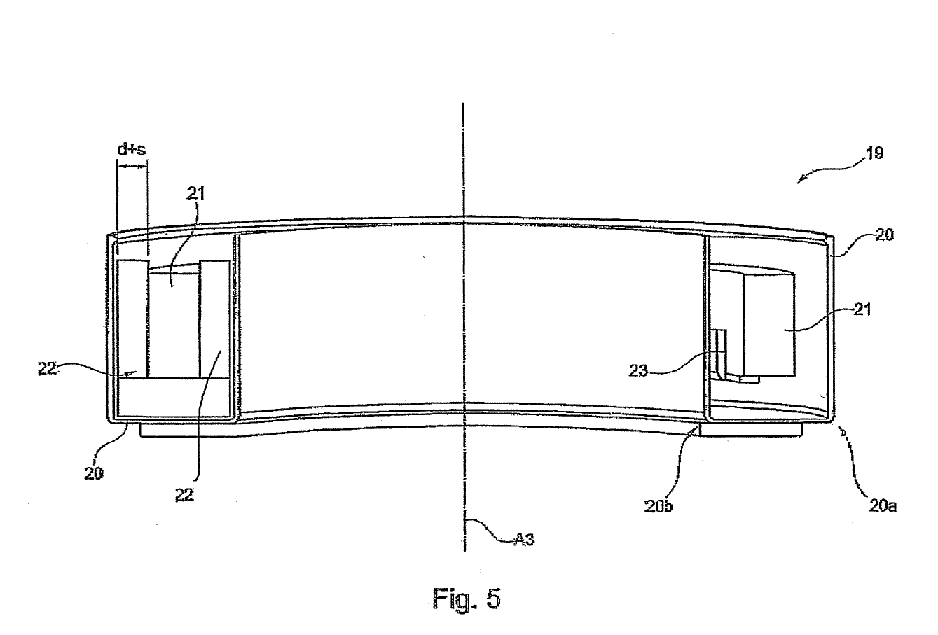

FIG. 5 shows an electromagnet 19 of a further alternative arrangement according to the invention. The circular electromagnet 19, which is formed with respect to a center axis A3, comprises a comparatively thin-walled steel body 20 composed of a shaped sheet-metal material. The thin-walled steel body 20 makes it possible to produce comparatively small shaping radii in bend areas 20a, 20b of the steel body 20, thus allowing comparatively very good utilization of the physical space for accommodation of a coil 21 with a surrounding magnetic-field guide. A magnetic-field guide element 22 is incorporated, as illustrated in a highly schematic form, on the left-hand side of FIG. 5, in the intermediate areas between the coil 21 and the U-shaped steel body 20, and has a thickness d+s in the radial direction on both sides of the coil 21, illustrating, with reference to FIG. 1, that the high magnetic permeability capability of the magnetic-field guide element 22, can be introduced over comparatively large radial areas. The introduction of the magnetic-field guide element 22 in the intermediate spaces between the coil 21 and the steel body 20 takes place in particular after the positioning of the coil 21 between the two limbs of the U-shaped steel body 20, in particular by means of an injection-molding process.

The right-hand side of FIG. 5 shows the coil 21 without the magnetic-field guide element 22, in which case a holding part 23 can be seen via which the coil 21 is held in the correct position in the steel body 20.

### LIST OF REFERENCE SYMBOLS

1 Electromagnet
2 Steel body
3 Coil former
4 Flange ring
5 Shaft
6 Ball-bearing arrangement
7 Sleeve section
8 Electromagnet
9 Magnet body
9a Section
10 Coil
11 Intermediate area
12 Ball bearing
13 Electromagnet
14 Coil
15 Magnetic-field guide element
15a Inner wall
15b Outer wall
16 Outer rib
17 Cable holder
18 Cable holder
19 Electromagnet
20 Steel body
20a Bend area
20b Bend area
21 Coil
22 Magnetic-field guide element
23 Holding part

1. An apparatus having an electromagnet, comprising a coil and a magnetic-field guide at least partially surrounding the coil, wherein the coil is provided with a sprayed or cast casing which forms the magnetic-field guide, and the magnetic-field guide is formed from a material comprising ferromagnetic metal particles and a plastic.

2. (canceled)

3. The apparatus according to claim 1, wherein the material for the magnetic-field guide includes at least 80% by mass ferromagnetic metal particles.

4. The apparatus according to claim 1, wherein the material for the magnetic-field guide includes at most 20% by mass plastic.

5. The apparatus according to claim 1, wherein the magnetic-field guide formed completely as an injection-molded component.

6. The apparatus according to claim 1, wherein the magnetic-field guide further comprises a housing part.

7. A clutch, for a motor vehicle, comprising the apparatus according to claim 1.

8. A method for producing an electromagnet having a coil and a magnetic-field guide at least partially surrounding the coil by an injection-molding process.

9. The method according to claim 10, wherein the magnetic-field guide is formed by extrusion coating of at least parts of the coil.

10. The method according to claim 10, wherein the magnetic-field guide is formed from a material that comprises metal particles and has ferromagnetic characteristics.

11. The method according to claims 10, further comprising the step of positioning the coil in an area between sections of a housing part of the magnetic-field guide, and then injection molding the material for the magnetic-field guide into free spaces between the coil and the sections of the housing part.

12. The apparatus according to claim 1, wherein the material for the magnetic-field guide includes about 95% by mass ferromagnetic metal particles.

13. The apparatus according to claim 1, wherein the material for the magnetic-field guide includes about 5% by mass plastic.

14. The apparatus according to claim 6, wherein the housing part is a shaped steel body.
